(19) United States
(12) Patent Application Publication
(10) Pub. No.: US 2026/0009629 A1
(43) Pub. Date: Jan. 8, 2026

(54) SYSTEMS, APPARATUSES, AND METHODS FOR ENHANCING DIMENSIONAL VERIFICATION OF TEST SPECIMENS

(71) Applicant: MARATHON PETROLEUM COMPANY LP, Findlay, OH (US)

(72) Inventors: Alex M. Markins, Findlay, OH (US); Nicci R. Triche, Findlay, OH (US); John J. Langenfeld, Findlay, OH (US)

(21) Appl. No.: 18/909,498

(22) Filed: Oct. 8, 2024

Related U.S. Application Data
(60) Provisional application No. 63/667,233, filed on Jul. 3, 2024.

(51) Int. Cl. G01B 3/30; G01B 5/06; G01N 17/04

(52) U.S. Cl. CPC G01B 3/30; G01B 5/06; G01N 17/04

(57) ABSTRACT

An embodiment of a dimension verification gauge and related methods to enhance dimensional verification of a corrosion test specimen, may include a gauge body at least partially defining a gauge body outer surface. The dimension verification gauge further may include one or more gauge recesses in the gauge body outer surface. The one or more gauge recesses may have (a) a recess perimeter at least partially defining a recess opening and (b) a recess depth. One or more of (a) the recess perimeter or (b) the recess depth, may have a size corresponding to one of a minimum dimension or a maximum dimension, and the one or more of the minimum dimension or the maximum dimension may correspond to a predetermined dimension specification for the corrosion test specimen. A method for verifying dimensions of a corrosion test specimen may include observing a relative fit between a corrosion test specimen and a gauge recess.

### CROSS REFERENCE TO RELATED APPLICATIONS

This application claims priority to, and the benefit of U.S. Provisional Application No. 63/667,233, filed Jul. 3, 2024, titled “SYSTEMS, APPARATUSES, AND METHODS FOR ENHANCING DIMENSIONAL VERIFICATION OF TEST SPECIMENS,” the disclosure of which is incorporated herein by reference in its entirety.

### TECHNICAL FIELD

The present disclosure relates to systems, apparatuses, and methods for enhancing dimensional verification of test specimens and, more particularly, to systems, apparatuses, and methods for enhancing dimensional verification of corrosion test specimens.

### BACKGROUND

Metallic corrosion test specimens may be used to detect the presence of corrosive elements in substances or the corrosiveness of such elements. For example, corrosiveness may be an important hydrocarbon property that may affect the quality of the hydrocarbon and/or the efficiency of production, transportation, and refining operations associated with the hydrocarbon. For example, the corrosiveness associated with liquified natural gas (LNG) may be an important property. The corrosiveness associated with a sample of LNG may be determined by using a metallic test specimen to detect the presence of elements in the LNG that are corrosive to the metallic test specimen. For example, a metallic test specimen may be exposed to an LNG sample to test the corrosiveness of the LNG, for example, according to various testing protocols.

According to some such testing protocols, once the test specimens have been used, they must be cleaned and prepared according to the corresponding protocol. Cleaning and preparation may often result in machining or polishing the test specimen, and repeated use and/or preparation of a test specimen for use according to the various protocols may result in changing the physical dimensions of the test specimen. If, however, the physical dimensions of a test specimen do not comply with the testing protocol dimensional tolerances, the test specimen may no longer be acceptable for use for the corrosion test. Thus, prior to using a test specimen, the physical dimensions of the test specimen must be verified by measuring the relevant dimensions of the test specimen according to the protocol. This may often require the use of measuring equipment, such as calipers, which may result in tedious and time consuming manual measurement of the test specimen dimensions. Additionally, the tedious nature of the manual measurements may result in measurement errors, which may adversely affect the accuracy of corrosion testing using a test specimen that does not comply with the dimensional tolerances of the corresponding test protocol.

Accordingly, Applicant has recognized a need for verifying corrosion test specimen dimensions that may result in relatively more consistent and/or relatively more accurate verification of test specimen dimensions. The present disclosure may address one or more of the above-referenced considerations, as well as other possible considerations.

### SUMMARY

As referenced above, Applicant has recognized that verification of the physical dimensions of a test specimen may often require the use of measuring equipment, such as calipers, which may result in tedious and time consuming manual measurement of the test specimen dimensions. The tedious nature of the manual measurements may result in measurement errors, which may adversely affect the accuracy of corrosion testing using a test specimen that does not comply with the dimensional tolerances of the corresponding test protocol.

The present disclosure generally is directed to systems, apparatuses, and methods for enhancing dimensional verification of test specimens and, more particularly, to systems, apparatuses, and methods for enhancing dimensional verification of corrosion test specimens that may address one or more of the above-mentioned considerations, as well as possibly others. For example, in some embodiments, systems, apparatuses, and methods for enhancing verification of corrosion test specimen dimensions may result in relatively more consistent and accurate verification of test specimen dimensions. In some embodiments, a test specimen dimension verification gauge may be used to efficiently and accurately verify the physical dimensions of test specimens, such as metallic test strips and/or metallic cylinders used for corrosion testing.

In some embodiments, a dimension verification gauge to enhance dimensional verification of a corrosion test specimen may include a gauge body at least partially defining a gauge body outer surface. The dimension verification gauge further may include one or more gauge recesses in the gauge body outer surface. The one or more gauge recesses may have (a) a recess perimeter at least partially defining a recess opening and (b) a recess depth. One or more of (a) the recess perimeter or (b) the recess depth, may have a size corresponding to one of a minimum dimension or a maximum dimension, and the one or more of the minimum dimension or the maximum dimension may correspond to a predetermined dimension specification for the corrosion test specimen.

In some embodiments, a method for verifying dimensions of a corrosion test specimen may include moving a portion of the corrosion test specimen toward a gauge recess having (a) a recess perimeter at least partially defining a recess opening and (b) a recess depth, thereby to urge the portion of the corrosion test specimen through the recess opening and into the gauge recess. One or more of (a) the recess perimeter or (b) the recess depth, may have a size corresponding to one of a minimum dimension or a maximum dimension, and the one or more of the minimum dimension or the maximum dimension may correspond to a predetermined dimension specification for the corrosion test specimen. The method further may include observing a relative fit between the portion of the corrosion test specimen and the gauge recess, and determining, based at least in part on the relative fit, whether the corrosion test specimen meets the predetermined dimension specification.

In some embodiments, a method for preparing a corrosion test specimen for use in a corrosion test, may include one or more of (a) cleaning or (b) polishing, at least one surface of the corrosion test specimen. The method further may include verifying one or more dimensions of the corrosion test specimen. The verifying may include moving a portion of the corrosion test specimen toward a gauge recess having (a) a recess perimeter at least partially defining a recess opening and (b) a recess depth, thereby to urge the portion of the corrosion test specimen through the recess opening and into the gauge recess. One or more of (a) the recess perimeter or (b) the recess depth, may have a size corresponding to one of a minimum dimension or a maximum dimension, and the one or more of the minimum dimension or the maximum dimension may correspond to a predetermined dimension specification for the corrosion test specimen. The verifying further may include observing a relative fit between the portion of the corrosion test specimen and the gauge recess, and determining, based at least in part on the relative fit, whether the corrosion test specimen meets the predetermined dimension specification.

Still other aspects and advantages of these exemplary embodiments and other embodiments, are discussed in detail herein. Moreover, it is to be understood that both the foregoing information and the following detailed description merely provide illustrative examples of various aspects and embodiments and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than can be necessary for a fundamental understanding of the embodiments discussed herein and the various ways in which they can be practiced. According to common practice, the various features of the drawings discussed below are not necessarily drawn to scale. Dimensions of various features and elements in the drawings may be expanded or reduced to illustrate embodiments of the disclosure more clearly.

FIG. 1A is a schematic perspective view of an example dimension verification gauge for enhancing dimensional verification of a corrosion test specimen, according to embodiments of the disclosure.

FIG. 1B is a schematic top view of the example dimension verification gauge shown in FIG. 1A, according to embodiments of the disclosure.

FIG. 1C is a schematic side section view of the example dimension verification gauge shown in FIG. 1A, according to embodiments of the disclosure.

FIG. 2 is a schematic side section view of an example corrosion test cylinder including an example corrosion test specimen for detecting the presence of corrosive components in a liquified petroleum gas (LPG) sample contained in the corrosion test cylinder, according to embodiments of the disclosure.

FIG. 3A is a schematic perspective view of an example corrosion test strip, according to embodiments of the disclosure.

FIG. 3B is a schematic top view of the example corrosion test strip shown in FIG. 3A, according to embodiments of the disclosure.

FIG. 3C is a schematic side view of the example corrosion test strip shown in FIG. 3A, according to embodiments of the disclosure.

FIG. 3D is a schematic end view of the example corrosion test strip shown in FIG. 3A, according to embodiments of the disclosure.

FIG. 4A is a schematic perspective view of another example corrosion test strip, according to embodiments of the disclosure.

FIG. 4B is a schematic top view of the example corrosion test strip shown in FIG. 4A, according to embodiments of the disclosure.

FIG. 4C is a schematic side view of the example corrosion test strip shown in FIG. 4A, according to embodiments of the disclosure.

FIG. 4D is a schematic end view of the example corrosion test strip shown in FIG. 4A, according to embodiments of the disclosure.

FIG. 5A is a schematic perspective view of an example corrosion test cylinder, according to embodiments of the disclosure.

FIG. 5B is a schematic side view of the example corrosion test cylinder shown in FIG. 5A, according to embodiments of the disclosure.

FIG. 5C is a schematic end view of the example corrosion test cylinder shown in FIG. 5A, according to embodiments of the disclosure.

FIG. 6A is a schematic partial section view showing an end of an example corrosion test strip being moved toward and received in an example gauge recess of an example dimension verification gauge, according to embodiments of the disclosure.

FIG. 6B is a schematic partial section view showing an end of another example corrosion test strip being moved toward the example gauge recess of the example dimension verification gauge shown in FIG. 6A, according to embodiments of the disclosure.

FIG. 6C is a schematic partial section view showing a side of an example corrosion test strip being moved toward and received in an example gauge recess of an example dimension verification gauge, according to embodiments of the disclosure.

FIG. 6D is a schematic partial section view showing a side of another example corrosion test strip being moved toward the example gauge recess of the example dimension verification gauge shown in FIG. 6C, according to embodiments of the disclosure.

FIG. 6E is a schematic partial section perspective view showing a portion of an example corrosion test strip being moved toward an example gauge recess of an example dimension verification gauge, according to embodiments of the disclosure.

FIG. 6F is a schematic partial section perspective view showing a portion of another example corrosion test strip received in the example gauge recess of the example dimension verification gauge shown in FIG. 6E, according to embodiments of the disclosure.

FIG. 6G is a schematic partial section perspective view showing a portion of another example corrosion test strip received in the example gauge recess of the example dimension verification gauge shown in FIG. 6E, according to embodiments of the disclosure.

FIG. 7A is a schematic partial section view showing an end of an example corrosion test cylinder being moved toward and received in an example gauge recess of an example dimension verification gauge, according to embodiments of the disclosure.

FIG. 7B is a schematic partial section view showing an end of another example corrosion test cylinder being moved toward the example gauge recess of the example dimension verification gauge shown in FIG. 7A, according to embodiments of the disclosure.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described may be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, in particular, to mean “including but not limited to,” unless otherwise stated. Thus, the use of such terms is meant to encompass the items listed thereafter, and equivalents thereof, as well as additional items. The transitional phrases “consisting of” and “consisting essentially of,” if present, are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

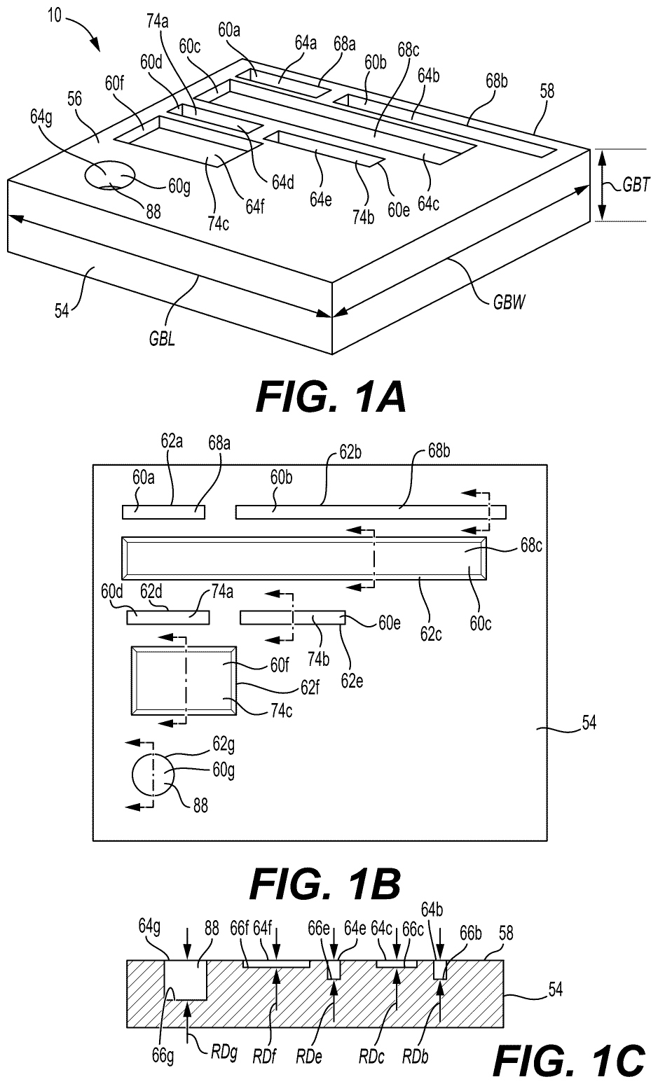

FIG. 1A is a schematic perspective view of an example dimension verification gauge 10 for enhancing dimensional verification of a corrosion test specimen, according to embodiments of the disclosure. FIG. 1B is a schematic top view of the example dimension verification gauge 10 shown in FIG. 1A, and FIG. 1C is a schematic side section view of the example dimension 10 verification gauge shown in FIG. 1A. In at least some embodiments, the dimension verification gauge 10 may enhance verification of corrosion test specimen dimensions, such that a verification results in relatively more consistent and/or relatively more accurate verification of test specimen physical dimensions. In some embodiments, the dimension verification gauge may be used to efficiently and/or accurately verify the physical dimensions of test specimens, for example, such as metallic test strips and/or metallic test cylinders used for corrosion testing.

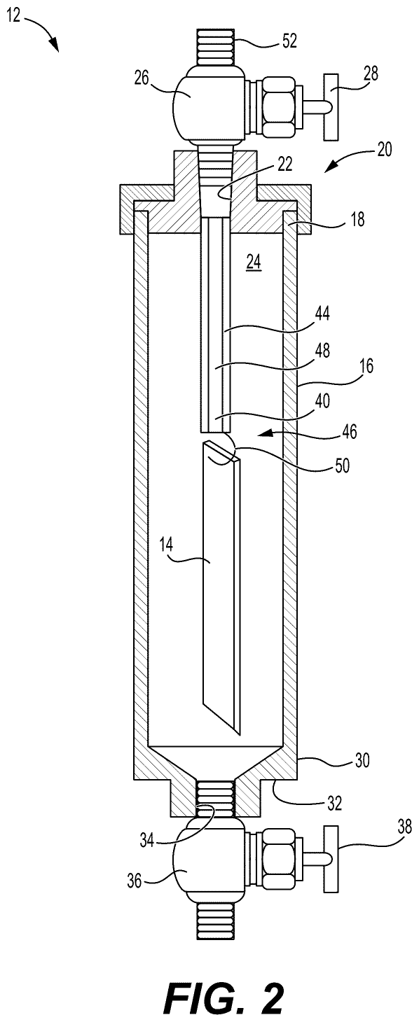

FIG. 2 is a schematic side section view of an example corrosion test cylinder 12 and an example corrosion test specimen 14 for detecting the presence of corrosive components in a liquified petroleum gas (LPG) sample contained in the corrosion test cylinder 12, according to embodiments of the disclosure. For example, as shown in FIG. 2, the corrosion test cylinder 12 may include a cylindrical body 16, including a first end 18 closed via a first cylinder cap 20 at least partially defining an inlet orifice 22, through which a material for testing may be selectively supplied to an interior 24 of the corrosion test cylinder 12. As shown in FIG. 2, an inlet valve 26 may be connected to the first cylinder cap 20, for example, such that the inlet valve 26 is at least partially received in the inlet orifice 22, for example, via complimentary threads on an interior surface the inlet orifice 22 and an exterior surface of the inlet valve 26. The inlet valve 26 may be configured to selectively transition from an open condition, allowing flow of material into the corrosion test cylinder 12 via the inlet orifice 22, to a closed condition, preventing the flow of material from the corrosion test cylinder 12 via the inlet orifice 22. For example, as shown, the inlet valve 26 may include a handle 28 configured to move a valve body of the inlet valve 26 between the open condition and the closed condition, for example, via rotation of the handle 28.

As shown in FIG. 2, a second end 30 of the cylindrical body 16 longitudinally opposite the first end 18 may be closed via a second cylinder cap 32 at least partially defining an outlet orifice 34, through which a material for testing may be selectively removed from the interior 24 of the corrosion test cylinder 12. As shown in FIG. 2, an outlet valve 36 may be connected to the second cylinder cap 32, for example, such that the outlet valve 36 is at least partially received in the outlet orifice 34, for example, via complimentary threads on an interior surface the outlet orifice 34 and an exterior surface of the outlet valve 36. The outlet valve 36 may be configured to selectively transition from a closed condition, preventing the flow of material from the corrosion test cylinder 12 via the outlet orifice 34, to an open condition, allowing the flow of the material from the corrosion test cylinder 12 via the outlet orifice 34. For example, as shown, the outlet valve 36 may include a handle 38 configured to move a valve body of the outlet valve 36 between the closed condition and the open condition, for example, via rotation of the handle 38.

In some embodiments, as shown in FIG. 2, the corrosion test cylinder 12 may include a test specimen fixture 40 configured to support a test specimen 14 at least partially. For example, as shown, an inlet tube 44 may extend from the inlet valve 26 toward an intermediate portion 46 of the interior 24 of the cylinder body 16 and provide a flow path 48 for a material to flow into the interior 24 upon opening of the inlet valve 26. In some embodiments, a hanger 50 may be connected to an end of the inlet tube 44 remote from the inlet valve 26, for example, as shown in FIG. 2. The hanger 50 may be configured suspend the test specimen 14 in the intermediate portion 46 of the cylinder body 16.

According to some embodiments, during corrosion testing of a test specimen 14, the first cylinder cap 20 may be separated from the cylinder body 16, thereby separating the test specimen fixture 40 from the cylinder body 16 and providing access to the test specimen fixture 40. The test specimen 14 may be connected to the test specimen fixture 40, for example, via the hanger 50. Thereafter, the test specimen 14, along with the test specimen fixture 40, may be inserted back into the interior 24 of the cylinder body 16, and the first cylinder cap 20 may be connected to the first end 18 of the cylinder body 16, thereby to suspend the test specimen 14 in the interior 24 of the cylinder body 16. The outlet valve 36 may be placed in the closed condition. A supply of the material for being tested may be connected to, for example, a connection boss 52 of the inlet valve 26. The inlet valve 26 may be placed in the open condition, for example, via rotation of the handle 28 of the inlet valve 26, allowing the material to flow into the interior 24 of the cylinder body 16, thereby to expose the test specimen 14 to the material. Once an amount of the material sufficient for the corrosion testing has been supplied to the interior 24 of the cylinder body 16, for example, according to a corrosion test protocol, the inlet valve 26 may be placed in the closed condition, for example, via rotation of the handle 28 of the inlet valve 26. Upon completion of the desired exposure of the test specimen 14 to the material, for example, according to a corrosion test protocol, the outlet valve 36 may be placed in the open condition, for example, via rotation of the handle 38 of the outlet valve 36, thereby allowing the material to flow from the interior 24 of the cylinder body 16.

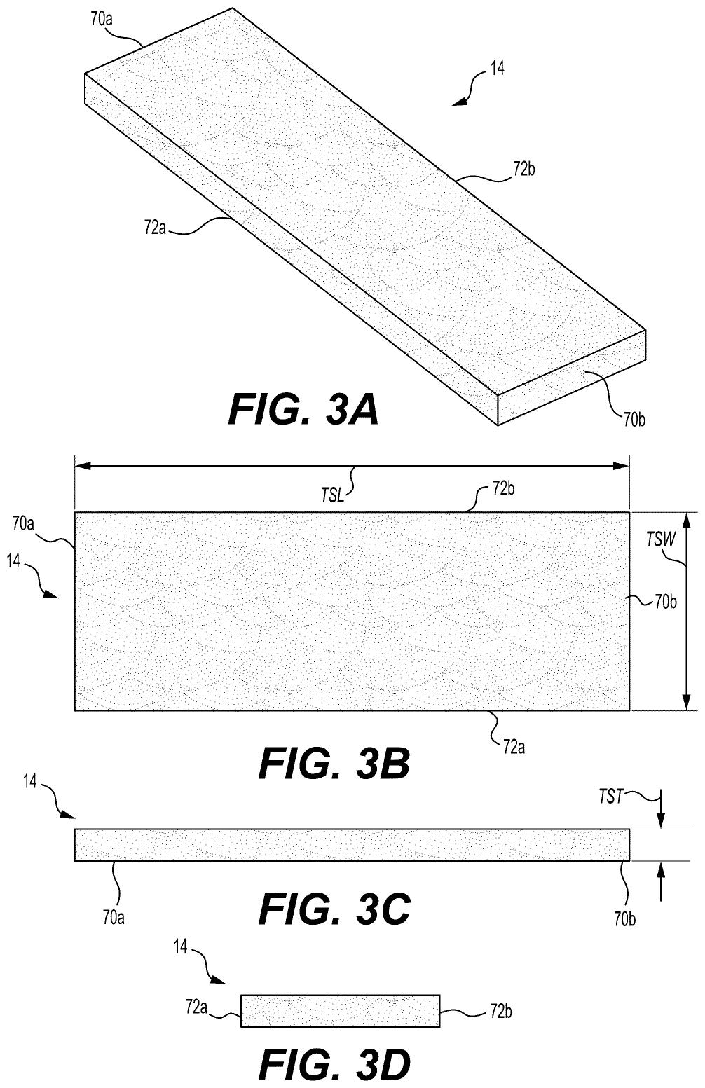

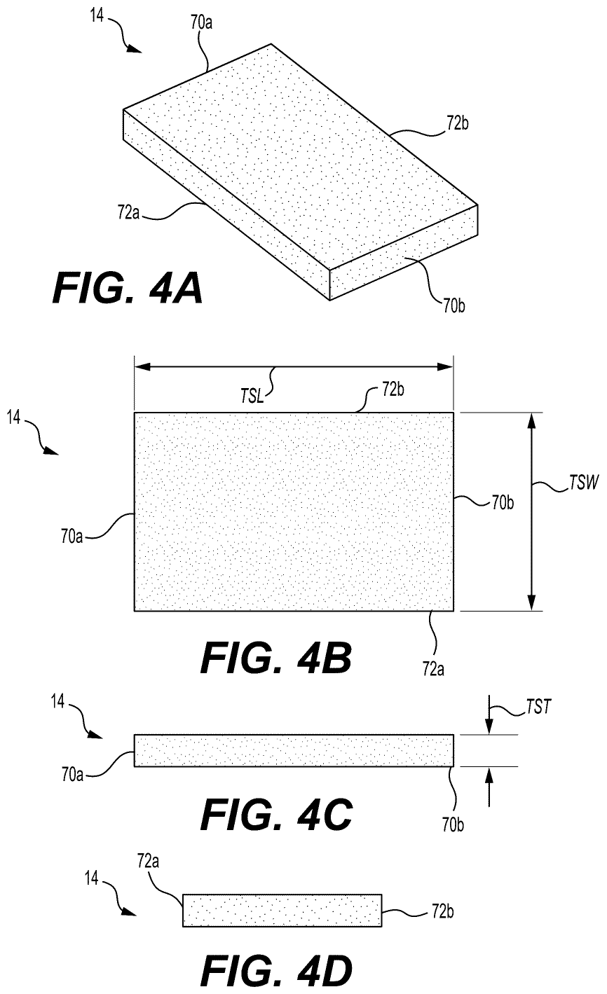

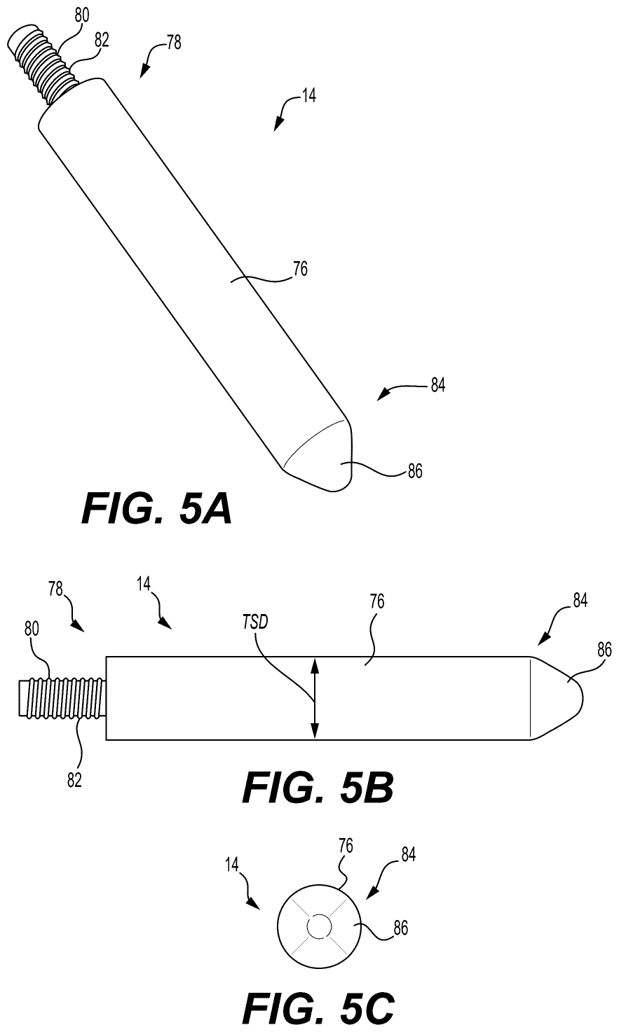

In some embodiments, the testing may include corrosion testing of the test specimen 14 according to one or more testing protocols, such as, for example, testing protocols according to ASTM and/or NACE. For example, the corrosiveness associated with a liquified natural gas (LNG) sample may be tested. The corrosiveness associated with a sample of LNG relative to copper may be determined by using a copper strip test specimen to detect the presence of elements in the LNG that are corrosive to copper. For example, as shown in FIG. 2, in some embodiments, the test specimen 14 may include a copper strip test specimen (see, e.g., FIGS. 3A, 3B, 3C, and 3D) suspended in the corrosion test cylinder 12, which may be at least partially filled with an LNG sample, to test the corrosiveness of the LNG sample relative to copper, for example, according to ASTM D130, “Standard Test Method for Corrosiveness to Copper from Petroleum Products by Copper Strip”; or according to ASTM D1838 “Standard Test Method for Copper Strip Corrosion by Liquefied Petroleum (LP) Gases.” In some embodiments, the test specimen 14 may include a silver strip test specimen (see, e.g., FIGS. 4A, 4B, 4C, and 4D) suspended in the corrosion test cylinder 12, which may be at least partially filled with an LNG sample, to test the corrosiveness of the LNG sample relative to silver, for example, according to ASTM D7671, “Standard Test Method for Corrosiveness to Silver by Automotive Spark-Ignition Engine Fuel-Silver Strip.” In some embodiments, the test specimen 14 may include a steel cylinder test specimen (see, e.g., FIGS. 5A, 5B, and 5C) suspended in the corrosion test cylinder 12, which may be at least partially filled with an LNG sample, to test the corrosiveness of the LNG sample relative to steel, for example, according to NACE TM0172, “Determining Corrosive Properties of Insoluble Petroleum Product Pipeline Cargoes.” Other testing protocols are contemplated, testing specimens having different compositions (e.g., other than copper, silver, and/or steel) are contemplated, and/or testing the corrosiveness of other materials (e.g., other than LNG) is contemplated.

According to some corrosiveness testing protocols, such as, for example, ASTM and NACE testing protocols, once a test specimen has been used, it may be reused, for example, depending on the condition of the test specimen. According to many protocols, prior to reuse, the previously used test specimen may be cleaned and/or prepared to prevent material from the previous test from affecting the next corrosiveness test. Many such protocols may specify the manner in which the test specimen may be cleaned and/or prepared. According to some protocols, cleaning and preparation may often result in polishing the test specimen, and repeated use and/or cleaning and preparing the test specimen for use according to such protocols may result in changing the physical dimensions of the test specimens. If, however, the physical dimensions of a test specimen do not comply with testing protocol specifications, the test specimen may no longer be used for the corrosion test according to such protocols. Thus, prior to using a test specimen, according to some protocols, the physical dimensions of the test specimen may be verified by measuring the relevant dimensions of the test specimen. Such measurements may be tedious, time consuming, and/or may result in measurement errors, which may adversely affect the accuracy of corrosion testing using test specimens that do not meet physical dimension specifications set forth according to the testing protocols.

Referring to FIGS. 1A, 1B, and 1C, according to at least some embodiments disclosed herein, the dimension verification gauge 10 may enhance dimensional verification of a corrosion test specimen, such as, for example, the corrosions test specimens 14 described herein, as well as others. In at least some embodiments, the dimension verification gauge 10 may enhance verification of corrosion test specimen dimensions, such that the verification results in relatively more consistent and/or relatively more accurate verification of test specimen dimensions. In some embodiments, the dimension verification gauge 10 may be used to efficiently and/or accurately verify the physical dimensions of test specimens, such as, for example, metallic test strips and/or metallic cylinders used for corrosion testing.

As shown in FIGS. 1A, 1B, and 1C, in some embodiments, the dimension verification gauge 10 may include a gauge body 54 at least partially defining a gauge body outer surface 56. The gauge body 54 may have a gauge body width GBW, a gauge body length GBL, and a gauge body thickness GBT, for example, as shown in FIG. 1A. The embodiment of gauge body 54 shown in FIGS. 1A, 1B, and 1C substantially defines a rectangular prism having six substantially planar faces with substantially parallel opposite faces. Other configurations of gauge body are contemplated. In some embodiments, as shown, the gauge body outer surface 56 includes a top surface 58, and the dimension verification gauge 10 includes a plurality of gauge recesses 60a, 60b, 60c, 60d, 60e, 60f, and 60g in the gauge body outer surface 56 (e.g., in the top surface 58). The gauge recesses 60a, 60b, 60c, 60d, 60e, 60f, and/or 60g may each have (a) a respective recess perimeter 62a, 62b, 62c, 62d, 62e, 62f, and/or 62g at least partially defining respective recess openings 64a, 64b, 64c, 64d, 64e, 64f, and/or 64g, and (b) respective recess depths RDa, RDb, RDc, RDd, RDe, RDf, and/or RDg (RDa and RDd not shown in FIG. 1C) at least partially defined by respective recess bases 66a, 66b, 66c, 66d, 66e, 66f, and/or 66g (66a and 66d not shown in FIG. 1C). In some embodiments, one or more of the recess bases 66a-66g may be substantially planar, although other surface configurations of the bases 66a-66g are contemplated.

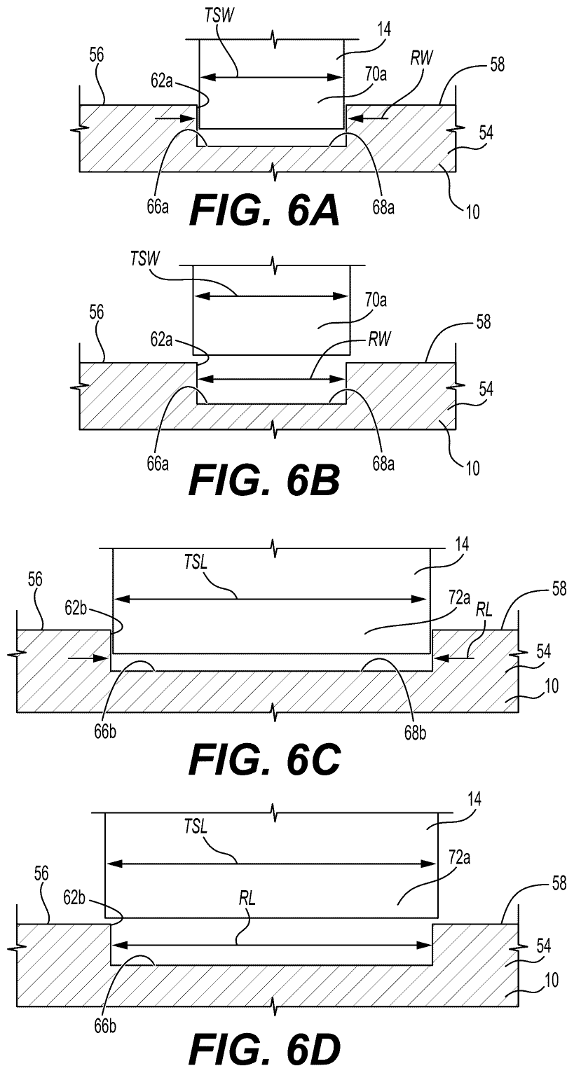

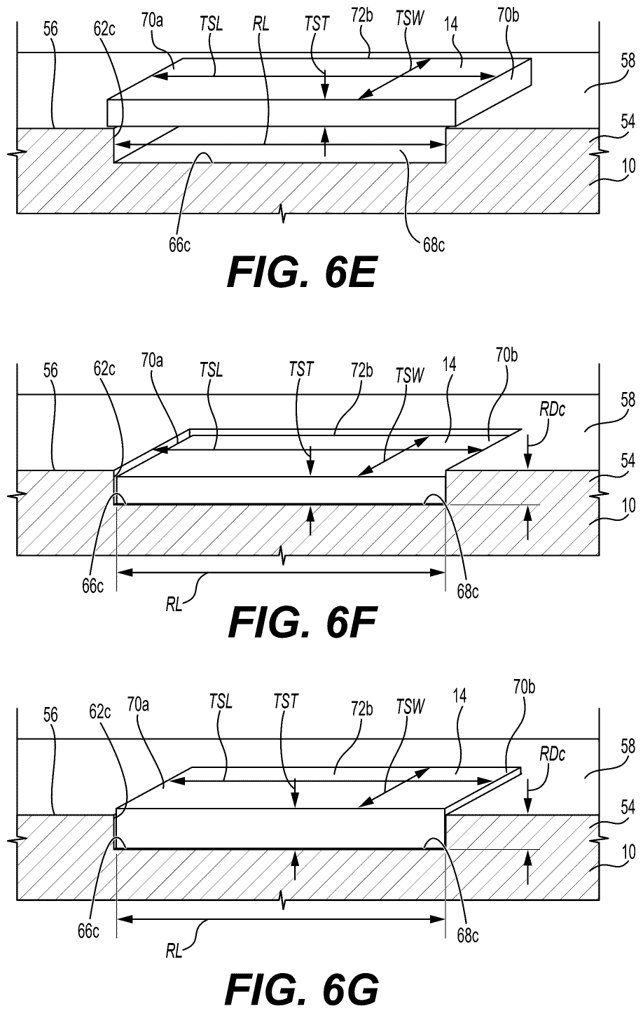

In some embodiments, one or more of the recess perimeters 62a-62g and/or one or more of the recess depths RDa-RDg may have a size substantially corresponding to either a minimum dimension or a maximum dimension. The minimum dimension and/or the maximum dimension may substantially correspond to a predetermined dimension specification, for example, for the corrosion test specimen 14. For example, depending on the type of corrosion test specimen 14, one or more of the recess perimeters 62a-62g may have a recess length RL and a recess width RW, for example, as shown in FIG. 6A through FIG. 6G. In some embodiments, the recess length RL may have a dimension corresponding to a minimum length for a test specimen length TSL of the test specimen 14 (see FIGS. 3B and 4B), which may correspond to a minimum length set forth according to a corrosion testing protocol. The recess width RW may have a dimension corresponding to a minimum width for a test specimen width TSW of the test specimen 14 (see FIGS. 3B and 4B), which may correspond to a minimum width set forth according to a corrosion testing protocol. In some embodiments, one or more of the recess depths RDa-RDg may have a dimension corresponding to a minimum depth for a test specimen thickness TST of the test specimen 14 (see FIGS. 3C and 4C), which may correspond to a minimum depth set forth according to a corrosion testing protocol.

In at least some such embodiments, for example, as explained with reference to FIG. 6A through FIG. 6G, the dimensions of the test specimen 14 may be verified by attempting to insert the test specimen 14 into one of the gauge recesses 60a-60g having a respective recess perimeter 62a, 62b, 62c, 62d, 62e, 62f, or 62g and/or a respective recess depth RDa, RDb, RDc, RDd, RDe, RDf, or RDg having a size substantially corresponding to a minimum dimension or a maximum dimension, for example, as set forth in a corresponding corrosion test protocol. For example, the dimensions of the test specimen 14 may be verified, for example, to show that the length TSL, width TSW, and/or thickness TST of the test specimen 14 (e.g., a copper strip test specimen or a silver test strip specimen) meets the physical dimension specifications set forth in a corresponding corrosion test protocol. In some embodiments, if the test specimen 14 is insertable, for example, when oriented in an orientation, such that a longitudinal axis of the test specimen 14 is substantially perpendicular to the gauge body outer surface 56 of the dimension verification gauge 10, into the appropriate one of the gauge recesses 60a-60g, then the test specimen 14 has a corresponding dimension less than the minimum dimension set forth in the testing protocol.

For example, as shown in FIG. 1A through FIG. 1C, in some embodiments, the gauge recesses 60a-60g may include a first set of gauge recesses 68a, 68b, and 68c configured to verify the physical dimensions of a particular type of corrosion test specimen 14. For example, the first set of gauge recesses 68a-68c may be configured to verify the physical dimensions of a copper strip test specimen 14, for example, as shown in FIG. 3A through FIG. 3D.

FIG. 3A is a schematic perspective view of an example corrosion test specimen 14 (e.g., a copper strip corrosion test specimen), according to embodiments of the disclosure. FIG. 3B is a schematic top view of the example corrosion test specimen 14 shown in FIG. 3A, FIG. 3C is a schematic side view of the example corrosion test specimen 14 shown in FIG. 3A, and FIG. 3D is a schematic end view of the example corrosion test specimen 14 shown in FIG. 3A.

In some embodiments, the first set of gauge recesses 68a-68c may include gauge recesses 68a and 68b, which may be configured to verify that the corrosion test specimen length TSL and the corrosion test specimen width TSW are greater than a minimum length specification and greater than a minimum width specification, respectively, as set forth in a corrosion testing protocol, for example, as set forth herein. The first set of gauge recesses 68a-68c may also include gauge recess 68c, which may be configured to verify that the corrosion test specimen thickness TST is greater than a minimum thickness specification set forth in a corrosion testing protocol, for example, as set forth herein.

As noted above, some embodiments of the dimension verification gauge 10 may be configured to verify the dimensions of one or more additional corrosion test specimens 14, for example, a corrosion test specimen 14 for use according to a second corrosion test protocol as set forth herein. For example, as shown in FIG. 1A through FIG. 1C, in some embodiments, the gauge recesses 60a-60g may include a second set of gauge recesses 74a, 74b, and 74c configured to verify the physical dimensions of a particular type of corrosion test specimen 14 (e.g., different than the dimensions of the type of corrosion test specimen 14 verified by the first set of gauge recesses 68a, 68b, and 68c). For example, the second set of gauge recesses 74a-74c may be configured to verify the physical dimensions of a silver strip test specimen 14, for example, as shown in FIG. 4A through FIG. 4D.

FIG. 4A is a schematic perspective view of another example corrosion test specimen 14 (e.g., a silver strip corrosion test specimen), according to embodiments of the disclosure. FIG. 4B is a schematic top view of the example corrosion test specimen 14 shown in FIG. 4A, FIG. 4C is a schematic side view of the example corrosion test specimen 14 shown in FIG. 4A, and FIG. 4D is a schematic end view of the example corrosion test specimen 14 shown in FIG. 4A.

In some embodiments, the second set of gauge recesses 74a-74c may include gauge recesses 74a and 74b, which may be configured to verify that the corrosion test specimen length TSL and the corrosion test specimen width TSW are greater than a minimum length specification and greater than a minimum width specification, respectively, as set forth in a corrosion testing protocol, for example, as set forth herein. The second set of gauge recesses 74a-74c may also include gauge recess 74c, which may be configured to verify that the corrosion test specimen thickness TST is greater than a minimum thickness specification set forth in a corrosion testing protocol, for example, as set forth herein. In some embodiments, the second set of gauge recesses 74-74c may be used in a manner at least similar to (e.g., the same as) the first set of gauge recesses 68a-68c, for example, as described with respect to FIGS. 6A-6G herein.

As shown FIG. 3A, the corrosion test specimen 14 may include opposing ends 70a and 70b. In some embodiments, the gauge recess 68a may be configured to verify that the corrosion test specimen 14 has a greater corrosion test specimen thickness TST and/or a greater corrosion test specimen width TSW than a respective minimum thickness and minimum width, according to a corrosion testing protocol.

FIG. 6A is a schematic partial section view showing an end 70a of an example corrosion test specimen 14 being moved toward, and received in, the example gauge recess 68a of an example dimension verification gauge 10, according to embodiments of the disclosure. As shown in FIG. 6A, in some embodiments, when the end 70a (and/or the end 70b) of the corrosion test specimen 14 fits into the gauge recess 68a, with the corrosion test specimen 14 oriented in an orientation, such that a longitudinal axis of the test specimen 14 is substantially perpendicular to the gauge body outer surface 56 of the dimension verification gauge 10, the corrosion test specimen thickness TST and/or the corrosion test specimen width TSW is/are smaller than the minimum corresponding thickness specification and/or the minimum corresponding width specification, according to the corrosion test protocol. Thus, the corrosion test specimen 14, according to such a protocol, should not be used for further testing under the corrosion test protocol.

FIG. 6B is a schematic partial section view showing an end 70a of another example corrosion test specimen 14 being moved toward but obstructed by the recess perimeter 62b of the example gauge recess 68b of an example dimension verification gauge 10, according to embodiments of the disclosure. As shown in FIG. 6B, in some embodiments, when the end 70a (and/or the end 70b) of the corrosion test specimen 14 shown in FIG. 6B is prevented from fitting into the gauge recess 68b, for example, because the corrosion test specimen thickness TST and/or the corrosion test specimen width TSW is/are larger than the minimum corresponding thickness specification and/or width specification, according to the corrosion test protocol, with the corrosion test specimen 14 oriented in an orientation, such that a longitudinal axis of the test specimen 14 is substantially perpendicular to the gauge body outer surface 56 of the dimension verification gauge 10, the corrosion test specimen thickness TST and/or the corrosion test specimen width TSW is/are larger than the minimum corresponding thickness specification and/or the minimum corresponding width specification, according to the corrosion test protocol. Thus, the corrosion test specimen 14, according to such a protocol, assuming other factors are acceptable, may be used for further testing under the corrosion test protocol.

FIG. 6C is a schematic partial section view showing a side 72a of opposing sides 72a and 72b of an example corrosion test specimen 14 being moved toward, and received in, the example gauge recess 68b of an example dimension verification gauge 10, according to embodiments of the disclosure. As shown in FIG. 6C, in some embodiments, when the side 72a (and/or the side 72b) of the corrosion test specimen 14 fits into the gauge recess 68b, as shown in FIG. 6C, with the corrosion test specimen 14 oriented in an orientation, such that an axis substantially perpendicular to a longitudinal axis of the test specimen 14 is substantially perpendicular to the gauge body outer surface 56 of the dimension verification gauge 10, the corrosion test specimen thickness TST and/or the corrosion test specimen length TSL is/are smaller than the minimum corresponding thickness specification and/or the minimum corresponding length specification, according to the corrosion test protocol. Thus, the corrosion test specimen 14, according to such a protocol, should not be used for further testing under the corrosion test protocol.

FIG. 6D is a schematic partial section view showing a side 72a of another example corrosion test specimen 14 being moved toward but obstructed by the recess perimeter 62b of the example gauge recess 68b of an example dimension verification gauge 10, according to embodiments of the disclosure. As shown in FIG. 6D, in some embodiments, when the side 72a (and/or the side 72b) of the corrosion test specimen 14 shown in FIG. 6D is prevented from fitting into the gauge recess 68b, for example, because the corrosion test specimen thickness TST and/or the corrosion test specimen length TSL is/are larger than the minimum corresponding thickness specification and/or the minimum corresponding length specification, according to the corrosion test protocol, with the corrosion test specimen 14 oriented in an orientation, such that an axis substantially perpendicular to a longitudinal axis of the test specimen 14 is substantially perpendicular to the gauge body outer surface 56 of the dimension verification gauge 10, the corrosion test specimen thickness TST and/or the corrosion test specimen length TSL is/are larger than the minimum corresponding thickness specification and/or the minimum corresponding length specification according to the corrosion test protocol. Thus, the corrosion test specimen 14, according to such a protocol, assuming other factors are acceptable, may be used for further testing under the corrosion test protocol.

In some embodiments, the gauge recess 68c of the first set of gauge recesses 68a-68c may be configured to verify that (1) the corrosion test specimen length TSL of the corrosion test specimen 14 is less than a maximum length dimension, according to the testing protocol, and/or (2) the corrosion tests specimen thickness TST of the corrosion test specimen 14 is greater than a minimum thickness dimension, according to the corrosion test protocol. As shown in FIG. 6E, in some embodiments, when the corrosion test specimen 14 will not fit into the gauge recess 68c, with the corrosion test specimen 14 oriented in an orientation, such that a longitudinal axis of the test specimen 14 is substantially parallel to the gauge body outer surface 56 of the dimension verification gauge 10, the corrosion test specimen length TSL (and/or potentially the corrosion test specimen width TSW) is/are larger than the maximum corresponding length specification (and/or the maximum corresponding width specification), according to the corrosion test protocol. Thus, the corrosion test specimen 14, according to such a protocol, should not be used for further testing under the corrosion test protocol.

FIG. 6F is a schematic partial perspective section view showing another example corrosion test specimen 14 being moved toward, and received in, the gauge recess 68c of the example dimension verification gauge 10, according to embodiments of the disclosure. As shown in FIG. 6F, in some embodiments, when the corrosion test specimen 14 shown in FIG. 6F fits into and is received by the gauge recess 68c, for example, because the corrosion test specimen length TSL and/or the corrosion test specimen width TSW is/are smaller than the maximum corresponding length and/or the maximum corresponding width specification, according to the corrosion test protocol, with the corrosion test specimen 14 oriented in an orientation, such that a longitudinal axis of the test specimen 14 is substantially parallel to the gauge body outer surface 56 of the dimension verification gauge 10, the corrosion test specimen length TSL and/or the corrosion test specimen width TSW is/are smaller than the maximum corresponding length specification and/or the maximum corresponding width specification, according to the corrosion test protocol. Thus, the corrosion test specimen length TSL and/or the corrosion test specimen width TSW of the corrosion test specimen 14, according to such a protocol, assuming other factors are acceptable, may be used for further testing under the corrosion test protocol if the corrosion test specimen thickness TST is greater than a minimum thickness, according to the corrosion test protocol.

For example, as shown in FIG. 6F, in some embodiments, the gauge recess 68c may be configured to verify whether the corrosion test specimen thickness TST of the corrosion test specimen 14 is greater than a minimum thickness specification, according to the corrosion test protocol. As schematically shown in FIG. 6F, although the corrosion test specimen 14 fits into the gauge recess 68c, the corrosion test specimen thickness TST is insufficient for the corrosion test specimen 14 to extend out of the gauge recess 68c beyond the recess perimeter 62c, for example, such that the corrosion test specimen 14 would cross (or pass through) an imaginary plane at least substantially defined by the recess perimeter 62c. In at least some embodiments, this is an indication that the corrosion test specimen thickness TST is less than a minimum thickness specification, according to the corrosion testing protocol. Thus, the corrosion test specimen 14 shown in FIG. 6F, according to such a protocol, should not be used for further testing under the corrosion test protocol.

FIG. 6G is a schematic partial perspective section view showing another example corrosion test specimen 14 being moved toward, and received in, the gauge recess 68c of the example dimension verification gauge 10, according to embodiments of the disclosure. As schematically shown in FIG. 6G, the corrosion test specimen 14 fits into the gauge recess 68c, and the corrosion test specimen thickness TST is sufficient for the corrosion test specimen 14 to extend out of the gauge recess 68c beyond the recess perimeter 62c, for example, such that the corrosion test specimen 14 crosses (or passes through) an imaginary plane at least substantially defined by the recess perimeter 62c. In at least some embodiments, this is an indication that the corrosion test specimen thickness TST is greater than a minimum thickness specification, according to the corrosion testing protocol. Thus, the corrosion test specimen 14 shown in FIG. 6G, according to such a protocol, assuming other factors are acceptable, may be used for further testing under the corrosion test protocol.

According to some embodiments, when a corrosion test specimen 14 is tested as shown in FIGS. 6A-6G, the dimension verification gauge 10 may be used to verify that the dimensions of the corrosion test specimen 14 fall between minimum and maximum acceptable dimensions according to the testing protocol, for example, without the use of other measurement tools, such as, for example, calipers, scales, rulers, lasers, and/or other distance measurement devices. In some embodiments, if the corrosion test specimen 14 fails a dimensional test associated with one or more of the gauge recesses (e.g., gauge recesses 68a, 68b, and/or 68c), then the corrosion test specimen 14 is not acceptable for use according to the corrosion test protocol. For example, in some embodiments, one or more of the gauge recesses 60a-60g, such as gauge recess 68a and 68b (and/or gauge recesses 74a and 74b), may be used to verify that the length, width, and/or thickness of the corrosion test specimen 14 are/is sufficiently large to be used according to the corrosion test protocol. In some embodiments, the gauge recess 68c (and/or the gauge recess 74c) may be used to verify that the length and/or width of the corrosion test specimen 14 are/is sufficiently small to be used according to the corrosion test protocol. In some embodiments, the gauge recess 68c (and/or the gauge recess 74c) also may be used to verify that the thickness of the corrosion test specimen 14 is sufficiently large to be used according to the corrosion test protocol.

FIG. 5A is a schematic perspective view of another example corrosion test specimen 14 (e.g., a cylinder corrosion test specimen), according to embodiments of the disclosure. FIG. 5B is a schematic side view of the example corrosion test specimen 14 shown in FIG. 5A, and FIG. 5C is a schematic end view of the example corrosion test specimen 14 shown in FIG. 5A. The corrosion test specimen 14 may, according to some embodiments, be a cylinder corrosion test specimen, for example, as shown in FIG. 5A through FIG. 5C. In some embodiments, the cylinder corrosion test specimen 14 may be configured and/or corrosion tested according to a corrosion testing protocol, such as, for example, according to NACE TM0172, “Determining Corrosive Properties of Insoluble Petroleum Product Pipeline Cargoes.”

As shown in FIGS. 5A-5C, the corrosion test specimen 14 may include a specimen body 76 being substantially solid and having a substantially cylindrical configuration. As shown in FIGS. 5A and 5B, the specimen body 76 may have connection end 78 including a connector 80 configured to connect the corrosion test specimen 14 to the interior of the corrosion test cylinder 12 (see, e.g., FIG. 2), for example, via the hanger 50 and/or the connection boss 52. For example, the connector 80 of the corrosion test specimen 14 shown in FIG. 5A-5C may include external threads 82 configured to engage with complimentary internal threads associated with the hanger 50 and/or the test specimen fixture 40 of the corrosion test cylinder 12, thereby to suspend the corrosion test specimen 14 in the interior 24 of the corrosion test cylinder 12 for corrosion testing, for example, as described herein and/or according to one or more corrosion testing protocols. As shown in FIGS. 5A-5C, the corrosion test specimen 14 may include a remote end 84 opposite the connection end 78. In some embodiments, the specimen body 76 may have a substantially cylindrical configuration at least partially defined by a substantially constant outer surface diameter extending between the connection end 78 and the remote end 84, which may terminate in a substantially conical-shaped tip 86.

Referring to FIGS. 1A-1D, some embodiments of the dimension verification gauge 10 may include a substantially cylindrical gauge recess 88 configured to verify one or more dimensions of a cylindrical corrosion test specimen 14, for example, such as the corrosion test specimen 14 shown in FIGS. 5A-5C. In some embodiments, the gauge recess 88 may be configured to verify that the outer diameter of a cylindrical-shaped corrosion test specimen 14 (e.g., as shown in FIGS. 5A-5C) is greater than a minimum outer diameter, according to a corrosion testing protocol. In some embodiments, the gauge recess 88 may at least partially define a substantially circular recess perimeter 90 (at least similar to the recess perimeter 62g shown in FIG. 1C) having a recess diameter RDI and may have a recess depth RDC (at least similar to the recess depth RDg shown in FIG. 1C) at least as long as, or longer than, a longitudinal length of the conical-shaped portion of the tip 86 of the corrosion test specimen 14.

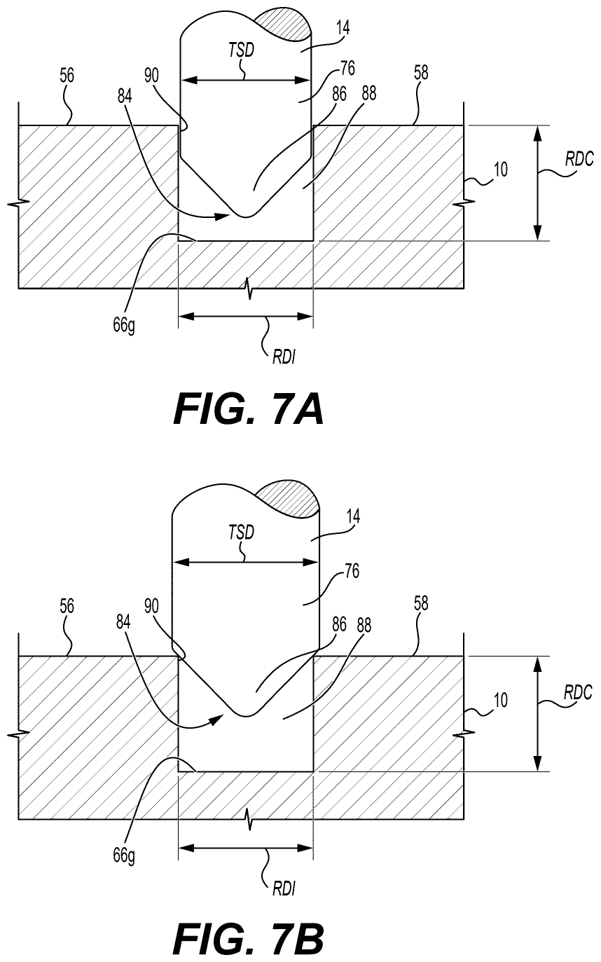

FIG. 7A is a schematic partial section view showing the tip 86 of an example corrosion test specimen 14 having a substantially cylindrical specimen body 76 being moved toward, and received in, the example gauge recess 88 of the example dimension verification gauge 10, according to embodiments of the disclosure. As shown in FIG. 7A, in some embodiments, when the tip 86 and a part of the longitudinal length of the cylindrical portion of the specimen body 76 adjacent the tip 86 of the corrosion test specimen 14 pass into the gauge recess 88 (e.g., beyond an imaginary plane at least partially defined by the recess perimeter 62g of the gauge recess 88), for example, as shown in FIG. 7A), with the corrosion test specimen 14 oriented in an orientation, such that a longitudinal axis of the test specimen 14 is substantially perpendicular to the gauge body outer surface 56 of the dimension verification gauge 10, the corrosion test specimen diameter TSD is smaller than the minimum corresponding diameter specification, according to the corrosion test protocol. Thus, the corrosion test specimen 14 shown in FIGS. 5A-5C, according to such a protocol, should not be used for further testing under the corrosion test protocol.

FIG. 7B is a schematic partial section view showing the tip 86 of another example corrosion test specimen 14 having a substantially cylindrical specimen body 76 being moved toward and obstructed by the recess perimeter 62g of the example gauge recess 88 of the example dimension verification gauge 10, according to embodiments of the disclosure. As shown in FIG. 7B, in some embodiments, when the tip 86 and a part of the longitudinal length of the cylindrical portion of the specimen body 76 adjacent the tip 86 of the corrosion test specimen 14 shown in FIG. 7B are prevented from fitting into the gauge recess 88, for example, because the corrosion test specimen diameter TSD is larger than the minimum corresponding diameter specification, according to the corrosion test protocol, with the corrosion test specimen 14 oriented in an orientation, such that a longitudinal axis of the test specimen 14 is substantially perpendicular to the gauge body outer surface 56 of the dimension verification gauge 10, the corrosion test specimen diameter TSD is larger than the minimum corresponding diameter specification, according to the corrosion test protocol. Thus, the corrosion test specimen 14, according to such a protocol, assuming other factors are acceptable, may be used for further testing under the corrosion test protocol.

In some embodiments, one or more of the gauge recesses shown in FIGS. 1A-1C may be provided in one or more respective gauge bodies, for example, instead of being provided on a common gauge body, such as, for example, the gauge body 54 shown in FIGS. 1A-1C. For example, according to some embodiments, a set of gauge recesses for verifying the dimensions (e.g., all the relevant dimensions) according to a particular corrosion test protocol (e.g., for a copper strip corrosion test specimen, for a silver strip corrosion test specimen, or a steel cylinder corrosion test specimen) may be provided on a common gauge body, for example, without other gauge recesses for verifying the dimensions of another type of corrosion test specimen having different dimensions according to a different protocol.

An example method for verifying dimensions of a corrosion test specimen, according to embodiments of the disclosure, is now described. The order in which the processes are described is not intended to be construed as a limitation, and any number of the described processes may be combined in any order and/or in parallel to implement the method.

The example method may include moving a portion of a corrosion test specimen toward a gauge recess having (a) a recess perimeter at least partially defining a recess opening and (b) a recess depth, thereby to urge the portion of the corrosion test specimen through the recess opening and into the gauge recess. One or more of (a) the recess perimeter or (b) the recess depth may have a size corresponding to one of a minimum dimension or a maximum dimension, and the one or more of the minimum dimension or the maximum dimension may correspond to a predetermined dimension specification for the corrosion test specimen. The example method further may include observing a relative fit between the portion of the corrosion test specimen and the gauge recess, and determining, based at least in part on the relative fit, whether the corrosion test specimen meets the predetermined dimension specification.

In some embodiments of the example method, the corrosion test specimen may include a corrosion test strip having a specimen length, a specimen width, and a specimen thickness. The recess opening may have a recess length and a recess width. The recess length may correspond to a minimum length specification for the corrosion test strip, and the recess width may correspond to a minimum width specification for the corrosion test strip. The example method, in some embodiments, may include determining that the corrosion test strip does not meet the predetermined dimension specification when a portion of corrosion test strip passes through the recess opening and into the gauge recess.

In some embodiments of the example method, the corrosion test specimen may include a corrosion test strip having a specimen length, a specimen width, and a specimen thickness. The recess depth may extend from the recess opening to a recess base, and the recess depth may correspond to a minimum thickness specification for the corrosion test strip. The example method, in some embodiments, may include determining that the specimen thickness meets the predetermined dimension specification when: (a) a portion of corrosion test strip passes through the recess opening and into the gauge recess, so that the corrosion test strip contracts the recess base, and (b) the corrosion test strip, while contacting the recess base, extends from the recess base beyond the recess opening. In at least some such embodiments of the example method, the example method may include positioning the corrosion test strip flat on the recess base in the gauge recess.

In some embodiments of the example method, the corrosion test specimen may have a specimen length, and the recess opening may have a recess length. The recess length may correspond to a maximum length specification for the corrosion test specimen. The recess depth may extend from the recess opening to a recess base. The example method, in some embodiments, may include determining that the corrosion test specimen meets the predetermined dimension specification when the portion of corrosion test specimen passes through the recess opening, so that the corrosion test specimen contacts the recess base. In at least some such embodiments of the example method, the example method may include positioning the corrosion test strip flat on the recess base in the gauge recess.

In some embodiments of the example method, the predetermined dimension specification may comply with one or more of: (a) American Society for Testing and Materials (ASTM) D130, (b) ASTM D1838, (c) ASTM D7671, or (d) National Association of Corrosion Engineers (NACE) TM0172.

An example method for preparing a corrosion test specimen for use in a corrosion test, according to embodiments of the disclosure, is now described. The order in which the processes are described is not intended to be construed as a limitation, and any number of the described processes may be combined in any order and/or in parallel to implement the method.

The example method may include one or more of (a) cleaning or (b) polishing, at least one surface of the corrosion test specimen, and verifying one or more dimensions of the corrosion test specimen. The verifying may include moving a portion of the corrosion test specimen toward a gauge recess having (a) a recess perimeter at least partially defining a recess opening and (b) a recess depth, thereby to urge the portion of the corrosion test specimen through the recess opening and into the gauge recess. One or more of (a) the recess perimeter or (b) the recess depth may have a size corresponding to one of a minimum dimension or a maximum dimension, and the one or more of the minimum dimension or the maximum dimension may correspond to a predetermined dimension specification for the corrosion test specimen. The example method further may include observing a relative fit between the portion of the corrosion test specimen and the gauge recess, and determining, based at least in part on the relative fit, whether the corrosion test specimen meets the predetermined dimension specification.

In some embodiments of the example method for preparing a corrosion test specimen for use in a corrosion test, the corrosion test specimen may include a corrosion test cylinder having a specimen diameter. The recess opening may have a recess diameter, and the recess diameter may correspond to a minimum diameter specification for the corrosion test cylinder. The example method, in some embodiments, may include determining that the corrosion test cylinder does not meet the predetermined dimension specification when a portion of corrosion test cylinder passes through the recess opening and into the gauge recess.

In some embodiments of the example method for preparing a corrosion test specimen for use in a corrosion test, the corrosion test specimen may include a corrosion test cylinder having a specimen diameter. The recess opening may have a recess diameter, and the recess diameter may correspond to a minimum diameter specification for the corrosion test cylinder. The example method, in some embodiments, may include determining that the corrosion test cylinder meets the predetermined dimension specification when a portion of corrosion test cylinder passes through the recess opening and into the gauge recess.

In some embodiments of the example method for preparing a corrosion test specimen for use in a corrosion test, the corrosion test specimen may include a corrosion test strip having a specimen length, a specimen width, and a specimen thickness. The recess depth may extend from the recess opening to a recess base, and the recess depth may correspond to a minimum thickness specification for the corrosion test strip. The example method, in some embodiments, may include determining that the specimen thickness meets the predetermined dimension specification when: (a) a portion of the corrosion test strip passes through the recess opening and into the gauge recess, so that the corrosion test strip contracts the recess base, and (b) the corrosion test strip, while contacting the recess base, extends from the recess base beyond the recess opening. In at least some such embodiments of the example method, the example method may include positioning the corrosion test strip flat on the recess base in the gauge recess.

In some embodiments of the example method for preparing a corrosion test specimen for use in a corrosion test, the corrosion test specimen may have a specimen length, and the recess opening may have a recess length. The recess length may correspond to a maximum length specification for the corrosion test specimen. The recess depth may extend from the recess opening to a recess base. The example method, in at least some such embodiments, may include determining that the corrosion test specimen meets the predetermined dimension specification when the portion of corrosion test specimen passes through the recess opening, so that the corrosion test specimen contacts the recess base. The example method, in at least some such embodiments, may include positioning the corrosion test specimen flat on the recess base in the gauge recess.

In some embodiments of the example method for preparing a corrosion test specimen for use in a corrosion test, the predetermined dimension specification may comply with one or more of: (a) American Society for Testing and Materials (ASTM) D130, (b) ASTM D1838, (c) ASTM D7671, or (d) National Association of Corrosion Engineers (NACE) TM0172.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems, methods, and/or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described.

This application claims priority to, and the benefit of U.S. Provisional Application No. 63/667,233, filed Jul. 3, 2024, titled “SYSTEMS, APPARATUSES, AND METHODS FOR ENHANCING DIMENSIONAL VERIFICATION OF TEST SPECIMENS,” the disclosure of which is incorporated herein by reference in its entirety.

Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiments, and numerous variations, modifications, and additions further may be made thereto without departing from the spirit and scope of the present disclosure as set forth in the appended claims.

What is claimed is:

1. A dimension verification gauge to enhance dimensional verification of a corrosion test specimen, the dimension verification gauge comprising:
a gauge body at least partially defining a gauge body outer surface;
one or more gauge recesses in the gauge body outer surface, the one or more gauge recesses having (a) a recess perimeter at least partially defining a recess opening and (b) a recess depth, one or more of (a) the recess perimeter or (b) the recess depth, having a size corresponding to one of a minimum dimension or a maximum dimension, and the one or more of the minimum dimension or the maximum dimension corresponding to a predetermined dimension specification for the corrosion test specimen.

2. The dimension verification gauge of claim 1, wherein:
the recess opening has a recess length and a recess width, the recess length corresponding to a minimum length specification for the corrosion test specimen and the recess width corresponding to a minimum width specification for the test specimen; and
when a portion of the test specimen being dimensionally verified passes through the recess opening and into the gauge recess, the corrosion test specimen does not meet the predetermined dimension specification.

3. The dimension verification gauge of claim 1, wherein:
the recess opening has a recess diameter, the recess diameter corresponding to a minimum diameter specification for the corrosion test specimen; and
when a portion of the test specimen being dimensionally verified passes through the recess opening and into the gauge recess, the corrosion test specimen does not meet the predetermined dimension specification.

4. The dimension verification gauge of claim 1, wherein:
the gauge recess has a recess depth extending from the recess opening to a recess base, the recess depth corresponding to a minimum thickness specification for the corrosion test specimen; and
when (a) a portion of test specimen being dimensionally verified passes through the recess opening and into the gauge recess, so that the corrosion test specimen contracts the recess base, and (b) the corrosion test specimen, contacting the recess base, extends from the recess base beyond the recess opening, the specimen thickness meets the predetermined dimension specification.

5. The dimension verification gauge of claim 4, wherein:
the gauge recess has a recess depth extending from the recess opening to a recess base, the recess depth corresponding to a minimum thickness specification for the corrosion test specimen; and
when (a) a portion of test specimen being dimensionally verified passes through the recess opening and into the gauge recess, so that the corrosion test specimen contracts and lies flat against the recess base, and (b) the corrosion test specimen extends from the recess base beyond the recess opening, the specimen thickness meets the predetermined dimension specification.

6. The dimension verification gauge of claim 1, wherein:
the recess opening has a recess length, the recess length corresponding to a maximum length specification for the corrosion test specimen;
the gauge recess has a recess depth extending from the recess opening to a recess base; and
when the portion of test specimen passes through the recess opening, so that the corrosion test specimen contacts the recess base, the corrosion test specimen meets the predetermined dimension specification.

7. The dimension verification gauge of claim 6, wherein:
the recess opening has a recess length, the recess length corresponding to a maximum length specification for the corrosion test specimen;
the gauge recess has a recess depth extending from the recess opening to a recess base; and
when the portion of test specimen passes through the recess opening, so that the corrosion test specimen contacts and lies flat against the recess base, the corrosion test specimen meets the predetermined dimension specification.

8. The dimension verification gauge of claim 1, wherein the predetermined dimension specification complies with one or more of: (a) American Society for Testing and Materials (ASTM) D130, (b) ASTM D1838, (c) ASTM D7671, or (d) National Association of Corrosion Engineers (NACE) TM0172.

9. The dimension verification gauge of claim 1, wherein the recess perimeter is rectangular.

10. The dimension verification gauge of claim 1, wherein the gauge body outer surface includes a substantially planar face.

11. The dimension verification gauge of claim 1, wherein the recess base is substantially planar.

12. The dimension verification gauge of claim 1, wherein the one or more gauge recesses includes a plurality of gauge recesses.

13. The dimension verification gauge of claim 12, wherein the plurality of gauge recesses include:
a first gauge recess configured to at least partially dimensionally verifying a first corrosion test specimen; and
a second gauge recess configured to at least partially dimensionally verifying a second corrosion test specimen.

14. The dimension verification gauge of claim 12, wherein the plurality of gauge recesses include:
a first gauge recess having a rectangular recess perimeter; and
a second gauge recess having a circular recess perimeter.

15. A method for verifying dimensions of a corrosion test specimen, the method comprising:
moving a portion of the corrosion test specimen toward a gauge recess having (a) a recess perimeter at least partially defining a recess opening and (b) a recess depth, thereby to urge the portion of the corrosion test specimen through the recess opening and into the gauge recess, one or more of (a) the recess perimeter or (b) the recess depth, having a size corresponding to one of a minimum dimension or a maximum dimension, and the one or more of the minimum dimension or the maximum dimension corresponding to a predetermined dimension specification for the corrosion test specimen;
observing a relative fit between the portion of the corrosion test specimen and the gauge recess; and
determining, based at least in part on the relative fit, whether the corrosion test specimen meets the predetermined dimension specification.

16. The method of claim 15, wherein:
the corrosion test specimen includes a corrosion test strip having a specimen length, a specimen width, and a specimen thickness;
the recess opening has a recess length and a recess width, the recess length corresponding to a minimum length specification for the corrosion test strip and the recess width corresponding to a minimum width specification for the corrosion test strip; and
the determining comprises determining that the corrosion test strip does not meet the predetermined dimension specification when a portion of corrosion test strip passes through the recess opening and into the gauge recess.

17. The method of claim 15, wherein:
the corrosion test specimen includes a corrosion test cylinder having a specimen diameter;
the recess opening has a recess diameter, the recess diameter corresponding to a minimum diameter specification for the corrosion test cylinder; and
the determining comprises determining that the corrosion test cylinder does not meet the predetermined dimension specification when a portion of corrosion test cylinder passes through the recess opening and into the gauge recess.

18. The method of claim 15, wherein:
the corrosion test specimen includes a corrosion test strip having a specimen length, a specimen width, and a specimen thickness;
the recess depth extends from the recess opening to a recess base, the recess depth corresponding to a minimum thickness specification for the corrosion test strip; and
the determining comprises determining that the specimen thickness meets the predetermined dimension specification when: (a) a portion of corrosion test strip passes through the recess opening and into the gauge recess, so that the corrosion test strip contracts the recess base, and (b) the corrosion test strip, while contacting the recess base, extends from the recess base beyond the recess opening.

19. The method of claim 18, further comprising positioning the corrosion test strip flat on the recess base in the gauge recess.

20. The method of claim 15, wherein:
the corrosion test specimen has a specimen length;
the recess opening has a recess length, the recess length corresponding to a maximum length specification for the corrosion test specimen;
the recess depth extends from the recess opening to a recess base; and
the determining comprises determining that the corrosion test specimen meets the predetermined dimension specification when the portion of corrosion test specimen passes through the recess opening, so that the corrosion test specimen contacts the recess base.

21. The method of claim 20, further comprising positioning the corrosion test specimen flat on the recess base in the gauge recess.

22. The method of claim 15, wherein the predetermined dimension specification complies with one or more of: (a) American Society for Testing and Materials (ASTM) D130, (b) ASTM D1838, (c) ASTM D7671, or (d) National Association of Corrosion Engineers (NACE) TM0172.

23. A method for preparing a corrosion test specimen for use in a corrosion test, the method comprising:
one or more of (a) cleaning or (b) polishing, at least one surface of the corrosion test specimen; and
verifying one or more dimensions of the corrosion test specimen, the verifying including:
moving a portion of the corrosion test specimen toward a gauge recess having (a) a recess perimeter at least partially defining a recess opening and (b) a recess depth, thereby to urge the portion of the corrosion test specimen through the recess opening and into the gauge recess, one or more of (a) the recess perimeter or (b) the recess depth, having a size corresponding to one of a minimum dimension or a maximum dimension, and the one or more of the minimum dimension or the maximum dimension corresponding to a predetermined dimension specification for the corrosion test specimen;
observing a relative fit between the portion of the corrosion test specimen and the gauge recess; and
determining, based at least in part on the relative fit, whether the corrosion test specimen meets the predetermined dimension specification.

24. The method of claim 23, wherein:
the corrosion test specimen includes a corrosion test cylinder having a specimen diameter;
the recess opening has a recess diameter, the recess diameter corresponding to a minimum diameter specification for the corrosion test cylinder; and
the determining comprises determining that the corrosion test cylinder does not meet the predetermined dimension specification when a portion of corrosion test cylinder passes through the recess opening and into the gauge recess.

25. The method of claim 23, wherein:
the corrosion test specimen includes a corrosion test cylinder having a specimen diameter;
the recess opening has a recess diameter, the recess diameter corresponding to a minimum diameter specification for the corrosion test cylinder; and
the determining comprises determining that the corrosion test cylinder meets the predetermined dimension specification when a portion of corrosion test cylinder passes through the recess opening and into the gauge recess.

26. The method of claim 23, wherein:
the corrosion test specimen includes a corrosion test strip having a specimen length, a specimen width, and a specimen thickness;
the recess depth extends from the recess opening to a recess base, the recess depth corresponding to a minimum thickness specification for the corrosion test strip; and
the determining comprises determining that the specimen thickness meets the predetermined dimension specification when: (a) a portion of the corrosion test strip passes through the recess opening and into the gauge recess, so that the corrosion test strip contracts the recess base, and (b) the corrosion test strip, while contacting the recess base, extends from the recess base beyond the recess opening.

27. The method of claim 26, further comprising positioning the corrosion test strip flat on the recess base in the gauge recess.

28. The method of claim 23, wherein:
the corrosion test specimen has a specimen length;
the recess opening has a recess length, the recess length corresponding to a maximum length specification for the corrosion test specimen;
the recess depth extends from the recess opening to a recess base; and
the determining comprises determining that the corrosion test specimen meets the predetermined dimension specification when the portion of corrosion test specimen passes through the recess opening, so that the corrosion test specimen contacts the recess base.

29. The method of claim 28, further comprising positioning the corrosion test specimen flat on the recess base in the gauge recess.

30. The method of claim 23, wherein the predetermined dimension specification complies with one or more of: (a) American Society for Testing and Materials (ASTM) D130, (b) ASTM D1838, (c) ASTM D7671, or (d) National Association of Corrosion Engineers (NACE) TM0172.
